(19) United States
(12) Patent Application Publication
(10) Pub. No.: US 2001/0039002 A1
(43) Pub. Date: Nov. 8, 2001

(54) System and method for implementing and managing training programs over a network of computers

(76) Inventor: John Delehanty, Wilmette, IL (US)

Correspondence Address: Hopgood, Calimafde, Judlowe & Mondolino, 60 East 42nd Street, New York, NY, 10165, US

(21) Appl. No.: 09/788,954

(22) Filed: Feb. 20, 2001

Related U.S. Application Data
(60) Provisional application No. 60/183,567, filed on Feb. 18, 2000.

(51) Int. Cl. G09B 7/00; G06F 15/16

(52) U.S. Cl. 434/322; 707/104.1; 709/217; 706/927; 434/362; 434/350

(57) ABSTRACT

System and method for an improved training system implemented over a network of computers such as the Internet. The improved training system enables an administrator of a training program to implement a program that includes content targeted to the users, continual monitoring of a user's performance, and direct communications with the users based on performance. System and method defines reference content and actionable content (such as tests) that are accessible to users based upon security access parameters. The performance of a user's response to actionable content is tracked and monitored so that future content can be tailored to a user's performance.

### CROSS REFERENCE TO RELATED APPLICATION

This application claims benefit of co-pending U.S. Provisional Application No. 60/183,567 entitled “System for Implementing and Managing Education and Training Programs over a Network of Computers” filed Feb. 18, 2000, the contents of which are incorporated herein in its entirety.

### FIELD OF INVENTION

The present invention relates to a system and method for implementing and managing training programs. More specifically, the present invention relates to an integrated, targetable, and trackable system and method for training individuals and groups with user appropriate subsets of content over a network of computers, such as the Internet

### BACKGROUND OF THE INVENTION

In the last several years, there has been an explosion of interest in transacting business through interconnected computers and, in particular, in transacting business over the Internet and the World Wide Web. One of the greatest promises of the Web involves its use for training. The universal access, enhanced communications, rich text, targetability and graphic environment makes the Web ideal for supporting a wide variety of training needs, components and platforms. The Web can support many of the features of a large university and library, enhanced with the ability to participate anytime, anywhere, while having instantaneous access to tutorial, background, support, testing and related information and data gathering.

Through a Web interface, a user/trainee can be provided access to a very deep and ever-expanding resource of training and education materials without the difficulties and costs associated with traditional “brick and mortar” training. Web-based training can significantly reduce facility costs associated with training and save users the time and expense to travel to a common physical location.

Notwithstanding this importance and potential, the systems in place to train individuals and groups over the Web are archaic at best, with the market growing in volume but not in technological systems advancement.

The most common practice with Web-training's posting passive HTML information documents with nominal, non-integrated data capture, some requiring manual compilation and manipulation of data and messaging. In addition, many training initiatives simply involve restricting access to a Web-site via password-protection schemes and ignore on-line data capture entirely.

The problem with these types of systems is that they will not support the type of integrated, user-driven training that organizations would like to be able to provide. For example, a common training issue facing many businesses is requiring that their employees compete certain training programs as part of their jobs. These training programs can be driven by regulatory requirements such as making sure that certain employees are familiar with and understand the work place safety requirements of OSHA. These training programs can also be driven by insurance requirements such as where a company can obtain lower insurance premiums if its employees have completed certain training relating to sexual harassment in the workplace. These training programs can also be directed towards training for its professional employees such as actuaries, engineers or lawyers who must pass certain tests for professional certification or advancement.

For these and other types of training programs to be effective over a network of computers, a system is needed that not only provides static content, but also provides actionable content so that the administrator of the training program can determine whether or not the user/trainee is actually learning and progressing through the training material. The administrator also needs to be able to monitor a user's performance and adjust the training based on the user's performance. In a multiple user training program, it is also important that the administrator be able to communicate with the trainees in a similar manner that the administrator could communicate with the trainee as if the trainees were all in the same physical location.

The systems in place today simply do not provide the type of dynamic environment necessary to implement and administer a comprehensive training program over a network of computers like the Web.

It was with this understanding of the problems of the prior art that formed the impetus of the present invention.

### OBJECTS AND SUMMARY OF THE PRESENT INVENTION

It is therefore an object of the present invention to provide a data processing system, which can be configured to implement a training program over a network of computers.

It is a further object of the present invention to provide a Web-based training system that enables users and administrators of an organization's training programs to access the system from any communications device with a Web browser and a connection to the Internet.

It is a further object of the present invention to provide a data processing system that is targetable, displaying and making accessible only the content and message files intended for a specific user.

It is a further object of the present invention to enable the use of actionable content that requires the user to provide responses which must fall within specified parameters.

It is a further object of the present invention to permit the administrators of training programs to track users' performance in responding to actionable content and tailor the content the users receive based upon the users' performance.

It is a further object of the present invention to provide a method for administrators to communicate directly and in real time to a specific user or groups of users, which can be tied to user performance or based on any other reason the administrator may need to communicate directly with a user or group of users.

The above and other objects of the present invention are realized in a Web-based training system that enables an organization's training programs to be implemented and utilized by anyone with a Web browser enabled device and a connection to the Internet. The present invention enables administrators of training programs to implement a specific training program targeted to a specific set of users. The training programs include both reference content and actionable content. As a user proceeds through the actionable content of a training program, the system tracks the user's performance, and based on this performance, the administrator can, in real time or based on pre-programmed performance criteria, determine what, if any, additional training content should be made available to the user. The messaging functions of the present invention permit the administrator to communicate directly with the user as the training proceeds.

### BRIEF DESCRIPTION OF THE FIGURES

FIG. 1 is a block diagram of an illustrative example of a server computer for the present invention including its data structures.

FIG. 2 represents an example training environment in which multiple trainees at multiple locations are connected through the Internet to the illustrative server computer for the present invention depicted in FIG. 1.

FIG. 3 is a flow chart showing an example of a user's training session executed through a Web-interface.

FIG. 4(a) is a flow chart of the administration functions related to managing user data and reference content data.

FIG. 4(b) is a flow chart of the administration functions related to actionable content data.

FIG. 4(c) is a flow chart of the administration functions related to messaging and performance monitoring.

### DETAILED DESCRIPTION OF THE INVENTION

The present invention now will be described more fully hereinafter with reference to the accompanying drawings, in which an illustrative example of the present invention is shown. This invention may, however, be embodied in many different forms and should not be construed as limited to the illustrative example set forth herein; rather, this illustrative example is provided so that this disclosure will be thorough and complete, and will fully convey the scope of the invention to those skilled in the art.

The present invention is described below with reference to block diagrams and flow chart illustrations according to the illustrative example of the invention. It will be understood that each block of the block diagrams and the flow chart illustrations, and combinations of blocks in the block diagrams and combinations of blocks in the flow chart illustrations, can be implemented by computer program instructions. These computer instructions may be loaded onto a general purpose computer, special purpose computer, or other programmable data processing apparatus to produce a machine, such that the instructions which execute on the computer or other programmable data processing apparatus create means for implementing the functions specified in the block or blocks. It will be further understood that each block of the block diagrams and flow chart illustrations, and combinations of the respective blocks, can be implemented by a special purpose hardware-based computer systems which perform the specified functions or steps, or combinations of special purpose hardware and computer instructions.

The Illustrative Web-Based Training System

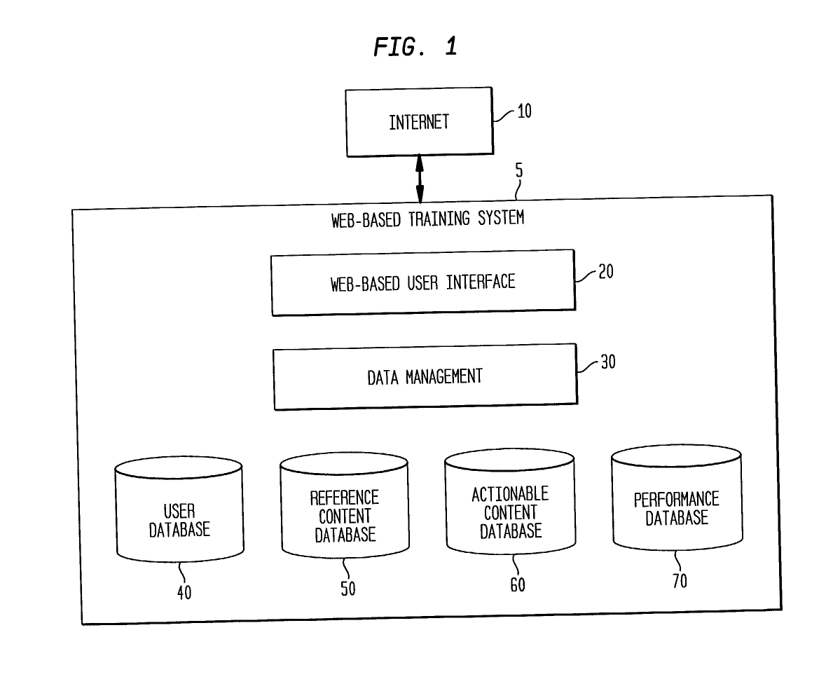

Referring now to FIG. 1, a block diagram of an illustrative example of a server computer for implementing the present invention is depicted. The illustrative server computer is loaded with Microsoft® Windows NT and Microsoft® IIS and configured as a Web server.

The Web server (5) in this illustrative example can be divided into two components, a Web-based user interface (20) component and a data management (30) component. The Web-based user interface (20) component serves up the various Web pages through which the system's users can, over the Internet (10), access the system's functionality and content. In this illustrative example, the Web pages are implemented using Microsoft ® Active Server Pages. The data management (30) component includes the application and data management programs that coordinate with the Web-based user interface component to receive, process, and store information entered by the system's users. In this illustrative example, the application programs were developed using C++ and the data management programs are implemented on Microsoft® Sequel Server.

In combination the programs implementing the Web-based user interface component and the data management component implement the functions of this illustrative example. These functions are described in the remaining sections of this Detailed Description.

It should be understood that the references herein to a server computer refer generally to any type of hardware or hardware combination configured with programming instructions to receive and respond to requests from client programs. A Web server as discussed herein is a server computer configured to respond to a client program by serving Web pages using standardized Internet protocols. The client program in a Web environment is referred to as a Web browser.

Currently, the primary standard protocol for allowing applications to locate and acquire Web documents is HTTP and the Web pages are encoded using HTML. A Web server as discussed herein is intended to encompass future markup languages and transport protocols which may be used in place of (or in addition to) HTML and HTTP.

Data Structures

Referring again to FIG. 1, the illustrative Web-Server is depicted as containing four databases. The databases are a User Database (40), a Reference Content Database (50), an Actionable Content Database (60), and a Performance Database (70). A database as used herein refers to a logical grouping of data and not to any particular physical structure. Each of these logical groups of data could be implemented by one or more physical structures located on one or more physical locations. In this illustrative example, the databases are configured using Microsoft® SQL Server.

The User Database (40) contains all the information maintained on the users of the system. This data structure includes data relating to Administrators of the system as well as data relating to the non-administrative users. These non-administrative users/trainees will hereinafter be referred to as “User-Trainees”. The information stored within the User Database includes such information as the identity of the user, whether the user has administrator functions, and the user's permission access, which is used by the system to determine training content to which he or she has access. This list of data is not intended to be inclusive of all data that can or may be stored within user data but is simply intended to illustrate the types of data that can be stored in the User Database.

The Reference Content Database (50) contains the information that an Administrator can make available to a User-Trainee for study, review, and reference for a particular training program. Reference Content is the deep and ever-growing library of related, support, background, and reference information materials, which a User-Trainee can access from any Web browser enabled device with a connection to the Internet. Reference Content can include static text, glossary definitions, policies, memos, news stories, white papers, chart graphics, samples on video and any other information an Administrator believes is relevant to the study of one or more training programs. Reference Content data also includes the access permission parameters that correspond with the User-Trainee's access permissions and enable an Administrator to target individual Users-Trainees by restricting access to only targeted User-Trainees for which the Reference Content is intended.

The Actionable Content Database (60) contains materials that an Administrator has designated as requiring a definitive action be taken by a User-Trainee beyond access and viewing. Actionable content are generally in the form of tests but can be set up as any type of document requiring a response such as a survey or a questionnaire. Actionable Content can be presented in any web-supported format—including text, graphics, audio/video, etc.—and tap any content category (definitions, policies, memos, white papers, chart graphics, samples on video, etc.).

Actionable Content data can also includes access permission parameters that correspond with the User-Trainee's access permissions and enable an Administrator to target individual User-Trainees by restricting access to only targeted User-Trainees for which the Actionable Content is intended. In addition, other administrative parameters are encoded into Actionable Content which can be used to specify such items as allowing the retaking of tests, assigning data filed requirements for responses and requiring 100% or variable accuracy in responses.

The Performance Database (70) contains the User-Trainee's responses to Actionable Content. This data is used by an Administrator to monitor a User-Trainee's progress through the training material and determine what further content should be made available to the trainee based on his or her performance. Example Environment for the Present Invention

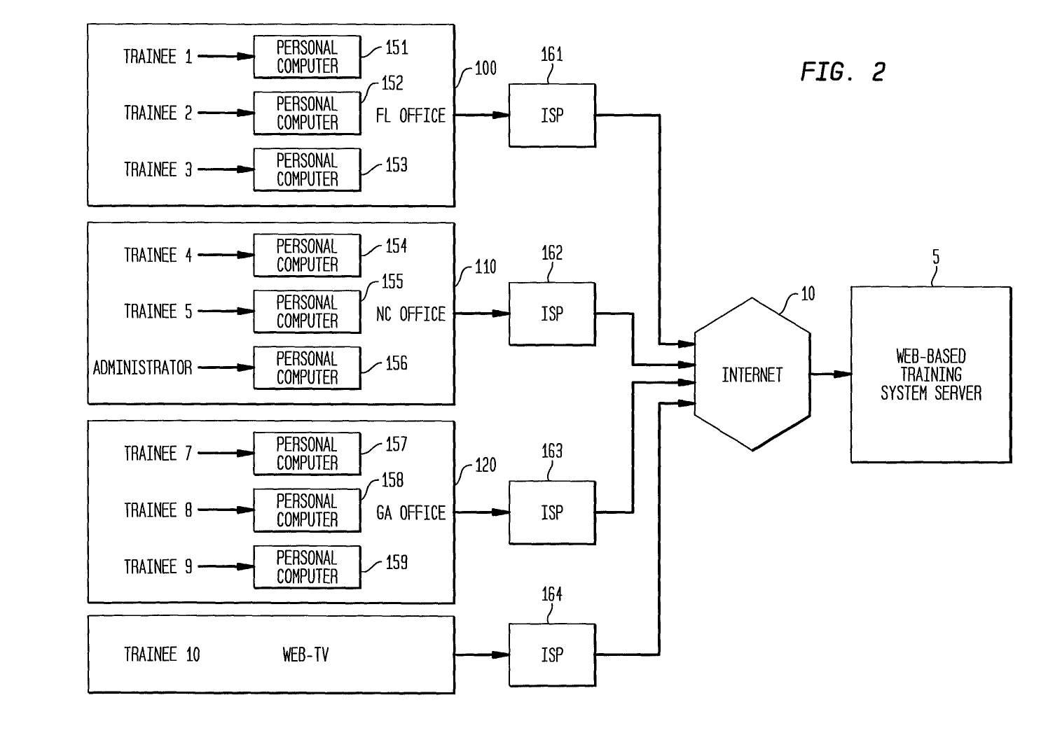

Referring now to FIG. 2, an example training environment is depicted in which multiple User-Trainees are connected through the Internet to the illustrative server computer for the present invention depicted in FIG. 1. In this example, an organization with three physical locations—a Florida office (100), a North Carolina office (110) and a Georgia office (120) is shown as providing a training program for ten employees referred to as Trainees 1 through 10. Trainees 1 through 3 are located in the Florida office, Trainees 4 and 5 are located in the North Carolina office and Trainees 7 through 9 are located in the Georgia office. Trainee 10 is not shown as being located at any physical location illustrating that a User-Trainee can be at any physical location with a Web browser and a connection to the Internet.

The Administrator for this training program is shown in this example as being located in the North Carolina office. The Administrator, like the User-Trainee, could be located at any physical location. All he or she needs is a Web browser and a connection to the Internet.

It should also be understood that an organization may well define multiple Administrators for the multiple training programs. For example, the Administrator shown here in the North Carolina office may be an Environmental, Health and Safety employee administering a training program on workplace safety issues and related OSHA requirements. For this same organization, Human Resources employee might be located in the Florida office and designated as the administrator for a training program on sexual harassment in the workplace. The User-Trainees of this program could be the same or different employees as the User-Trainees of the workplace safety program depending on what training the organization determined each of its employees required.

Continuing now with FIG. 2, User-Trainees 1 through 9 and the Administrator are shown as accessing the Web-based training system server (5) through Web browsers on personal computers (151-159). These Web browsers are connected to the Internet (10) through Internet Service Providers (161-164) associated with each location. Trainee 10 is shown as accessing the system through a Web-TV (170), which is a television configured with a Web browser and connected to the Internet (10) through an Internet Service Provider (160)

The User's Web-Interface

The User-Trainee's illustrative Web-based interface is broadly laid out in the following navigation sections, which include a Home Portal Page, a Reference Page, a Training Page, and a System Search Page. Each of these sections are Web pages that include links to further pages of content within each of these sections. These sections are described below.

Home Portal Page

The User-Trainee's Home Portal Page is designed as a gateway to the various training programs to which a User-Trainee has access. An Administrator can make a variety of information available through the User's Home Page. Examples include weekly news updates, which display the title of a news file, an abstract of a news file, its importance, and a clickable icon that links the title to the individual file associated with that abstract. An Administrator can use this to keep a User-Trainee up to date regarding the status of various training programs.

Another example of training information that can be posted on the Home Portal Page is refresher quizes. On the Home Portal Page, these can be set up to display the category title and a clickable icon that links to the individual file containing the refresher questions. This functionality puts the theory of “cumulative education” into powerful practice. Regular refresher tests, featuring a few focused and topical questions, are an effective and efficient way to seamlessly integrate effective learning into a User-Trainee's daily routine.

Also displayable on the Home Portal Page are Administrator Messages. The Administrator can post on each User-Trainee's Home Portal Page messages, which will display the category, title, and abstract, and a clickable icon that links to the individual file containing the content of an Administrator's message. When a User clicks on the icon, the file associated with that link is displayed for a user to review, and/or act upon. The message can be displayed for a set amount of time, until clicked upon once, or constantly until an Administrator removes or modifies it.

This is not intended to be an exclusive list of what can be displayed on a UserTrainee's Home Portal Page. Any information of any kind that can be stored and displayed can be posted on a User-Trainee's Home Portal Page per the input of an Administrator.

The Reference Page

The Reference Section is a comprehensive library of links including background, support, and other reference content designated for inclusion in this section by an Administrator.

Sub-sections here can include information such as a news archives, a glossary, frequently asked questions, laws and regulations. Again, these are only examples of the type of content that can be made available through the Reference Page.

The Training Page

The Training Section includes the materials and actionable content for the programs to which a User-Trainee has access. In this illustrative example, a clickable Table of Contents (TOC) is provided for each training program. The TOC consists of clickable links for each sub-section/chapter that, when clicked, links directly to the referenced document.

The Actionable Content corresponding to the sections of the training program can be linked to the TOC and/or linked within the specific Reference Content.

System Search Page

The Search Page allows a User-Trainee to search all of a User-Trainee's approved Reference Content. Through the links on the page, a User-Trainee can search his or her approved areas of the entire system or specified subsections. After a User-Trainee enters the search information and clicks the search button, the system processes the request and displays a dynamically-generated page listing the title and abstract of the resultant document(s) satisfying the search parameters along with a clickable link to the referred to page.

The User-Trainee's Training Process

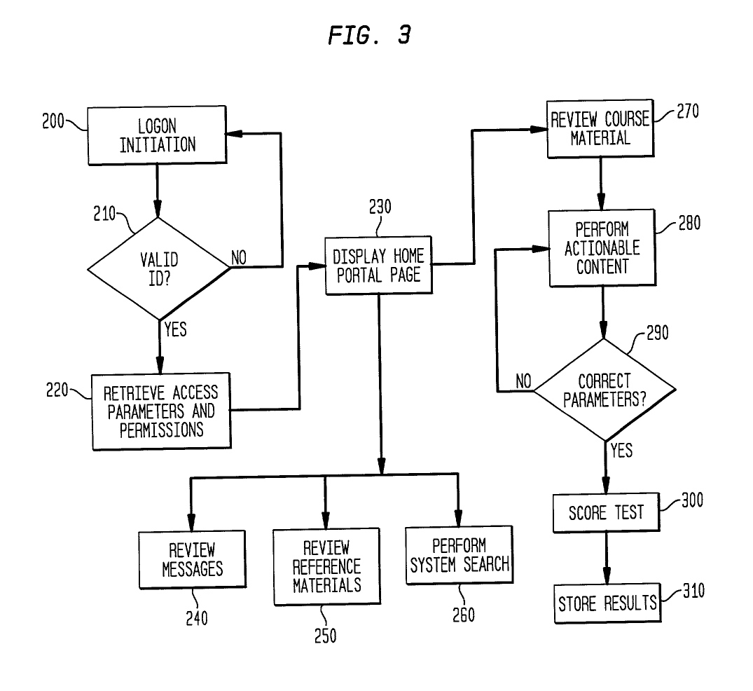

Referring now to FIG. 3, a flow chart showing an example of a User-Trainee's training session executed through the Web-interface is depicted. This is only an example of one possible training session. One of the unique features of the present invention is the flexibility an Administrator has to design a training session and the flexibility a User-Trainee has in working through a training session. A User-Trainee's training session begins with the Logon Initiation (200). The User-Trainee types in the Web address for the system and enters his or her User ID and Password. The Valid ID? (210) function determines if the User ID and Password is valid (210). If the User-Trainee enters a User ID and Password that matches the User-Trainee's information in the User Database, the User-Trainee's access is approved. If the information does not match, an error message is displayed and the User-Trainee is returned to the Logon Initiation.

If a User-Trainee is a approved, the Retrieve Access Parameters and Permissions Function (220) is performed. This function retrieves the User-Trainee's profile and associated access parameters and permissions from the User Database and applies them to the content stored in the Reference Database and in the Actionable Content Database. Based on what content a User-Trainee has access to, the Display Home Portal Page (230) function will return the Home Portal Page appropriate for his or her access parameters and permissions. From the Home Potal Page, a User-Trainee can navigate to the other sections of the system discussed above. A User-Trainee can also access any of the news or other messages that an Administrator has sent to the User-Trainee through the present invention's messaging capability.

Using the example environment described in FIG. 2, and continuing with the flowchart in FIG. 3, an example session will be described for Trainee 2, which is shown in FIG. 2 as an employee in the Florida office of a 3 offices organization.

After Trainee 2 completes the log on process steps described above, her Home Portal Page is displayed with the content she is authorized to view. In this example, the organization's Administrator for Environmental Health and Safety (EH&S) programs has sent to Trainee 2 an Administrator's message titled “Message, OSHA Training—Material Safety Data Sheets” with an icon that will link Trainee 2 to the text of the message.

Trainee 2 can perform the Review Messages (240) function and view the message by clicking on the icon for the message displayed on her Home Portal Page. She might then view a message like the following from the EH&S Administrator:

You have now successfully completed 3 of the 10 training units for OSHA compliance. The Fourth Unit is on Material Safety Data Sheets (MSDSs). For this unit, you need to be fully familiar with OSHA's Hazard Communication Regulations (29 CFR 1919. 1200) which is available through your Reference Page. Also included in your Reference Page is an article on MSDSs put out by the Chemical Manufacturers Association, which you might find helpful. The Unit 4 course material is accessible through the Training Page. When you are finished reviewing the course material and other reference material concerning MSDSs, you need to complete the Unit 4 test. The link for the Unit 4 test is at the end of the Unit 4 course material.

After reviewing this message, Trainee 2 can perform the Review Reference Materials (250) function by linking and clicking on the regulations and article that were made available by the Administrator. If Trainee 2 decides there is other reference content she needs to look at because she is confused about a topic covered in an earlier course, but she cannot recall what link contains the material, she can utilize the Perform System Search (260) function by linking to the System Search Page and performing a search to locate the desired reference content, which will be displayed as long as she is still defined as having access to this material.

When Traineee 2 wants to begin the course material, Trainee 2 can perform the Review Course Material (270) function by first linking to the Training Page, which contains links to the course material on MSDSs. The links provide a Table of Contents for the training program, and Trainee 2 can access the desired course material by clicking on the icon identifying the appropriate text material for the Unit 4 course.

When Trainee 2 is ready to take the Unit 4 test, she can execute the Perform Actionable Content (280) function by clicking on the Unit 4 test and responding to the questions. In this example, the link for the Unit 4 test was at the end of the course material.

After Trainee 2 completes the test and submits it for scoring, the Correct Parameters? (290) function will check each of Trainee 2's answers to make sure her answers are consistent with operational parameters as previously set by the Administrator for the questions. For example, a particular question may require that a number of some length be entered as a response. If Trainee 2 entered a response using letters instead of numbers, the system would direct the test back to Trainee 2 to enter a number response for the appropriate question. If the information does not fit the operational parameters, an error message is triggered stating the problem and the User-Trainee is returned to the Actionable Document to enter the correct data. If the information does fit the operational parameters, the Score Test (300) function will tally the result according to the answer key entered by the Administrator and the Store Results (310) function will store the results in the Performance Database.

Trainee 2 then can use the Navigation Bar to go to another document or section such as to access the material for another course or log off.

The Administration Process

The present invention includes a Web-enabled administration interface for implementing and managing training programs tailored for the needs of the User-Trainees as well as Administrators. Administrators are provided with special permissions that enables them to access and manipulate the core client data through the interface.

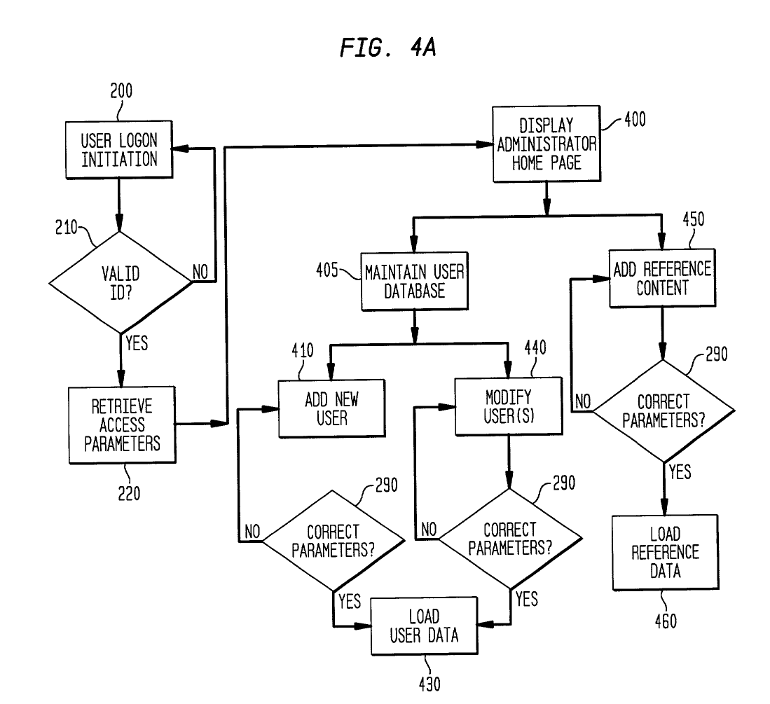

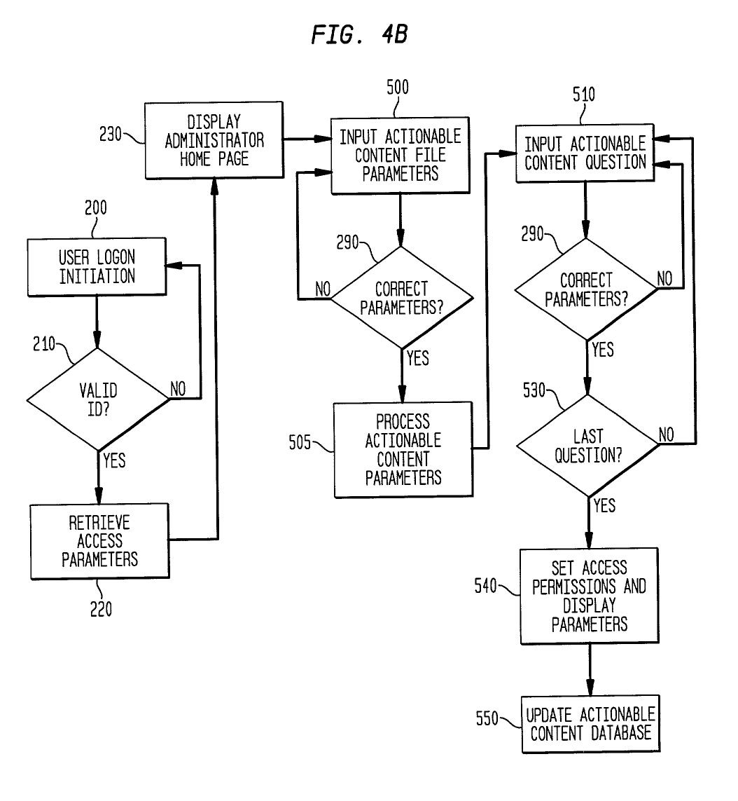

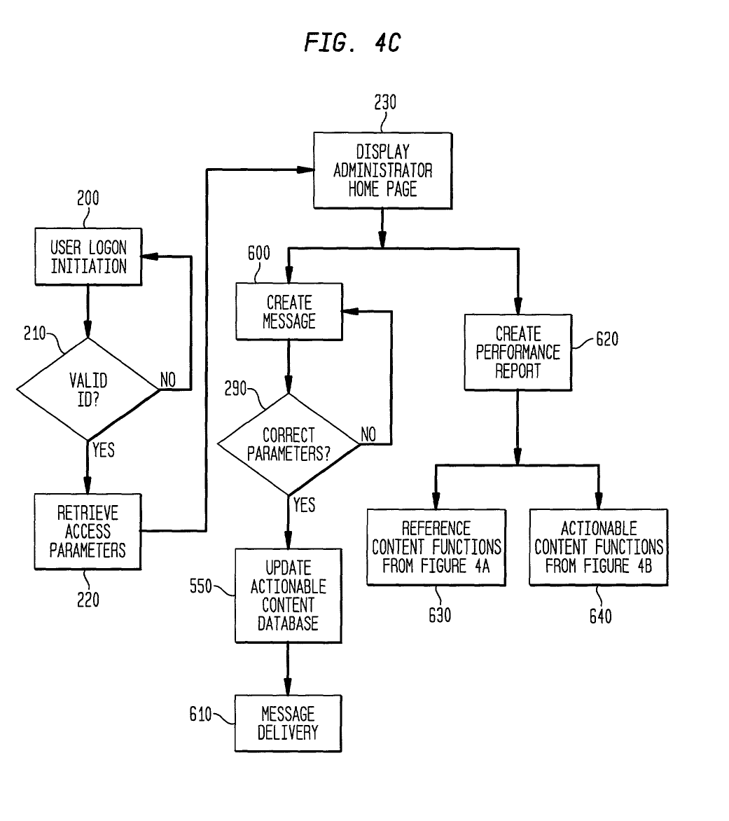

FIG. 4 shows a series of flow charts are shown to depict examples of the administration processes. FIG. 4(a) is a flowchart of the administration functions relating to managing user data and reference content data. FIG. 4(b) is a flow chart of the administration functions related to managing actionable content data. FIG. 4(c) is a flow chart of the administration functions related to messaging and performance monitoring.

Referring now to FIG. 4(a), the Logon Initiation (200) and the Valid ID? (210) functions are the same for an Administrator as for a User-Trainee. The difference in the process occurs during the Retrieve Access Parameters and Permissions (220) function because if the User is defined as an Administrator, the system will Display the Administrator's Home Page (400). The Administrator's Home Page provides various options for an Administrator to design and manage a training program. From the Home Page, an Administrator accesses the Maintain User Database (405) function by clicking the appropriate link. The Add New User (410) function is performed by clicking an icon for “add new User”, which will call and display a new User-Trainee profile form. On the form, the User-Trainee data and access permissions are entered and submitted. The Correct Parameters? (290) function checks the new information submitted for completeness per the operational parameters for User data. If the User data is incomplete, an error message is displayed and the Administrator is returned to the new User Form to complete the information.

If the User data is complete per the operational parameters, the Load User data (430) function is performed, which loads the data into the User Database (40).

To modify an existing User, after initiating the Maintain User Database function, an Administrator performs the Modify User(s) function (440) by clicking the “modify” option, which calls and displays a User Database searching interface which allows flexible search by any User data attribute of the User Profile (last name, first name, Social Security Number, State, etc.). The search parameter is entered and the request is processed with the results displayed in the Administrator's browser window. The Administrator selects the desired User-Trainee record by clicking on the linked text to access that Individual User Profile.

The Administrator modifies the Profile and clicks submit to continue. The Correct Parameters? (290) function checks the modified information submitted for completeness per the operational parameters for the User data. If the User data is incomplete, an error message is displayed and the Administrator is returned to the User Form to complete the information.

If the information is complete per the operational parameters, the Load User Data (430) function is performed, which loads the data into the User Database.

The Add Reference Content (450) function, beginning with the Administrator selecting the appropriate upload link from the Administrator Home Page. An Administrator assigns access parameters and permissions and the detail about the file to be uploaded including: file name or text, title, abstract, and date. After all this information is entered, the Administrator clicks “submit”. The Correct Parameters? (290) function processes the transaction and checks the file upload form for completeness per the operational parameters for this data.

If the information is not complete per the operational parameters, an error message is displayed and the administrator is returned to the upload form to complete the information. If the information is complete, the Load Reference Data (460) function loads the data into the Reference Content Database.

FIG. 4(b) is a flowchart of the administration functions related to managing actionable content data. After User Logon Initiation (200), Valid ID? (210), and Retrieve Access Parameters (220) functions are performed, the system will Display the Administrator Home Page (230) if the user is an Administrator. From the Home Page, an Administrator can add actionable content with the Input Actionable Content File Parameters (500) function. After selecting the appropriate link from the Administrators Home Page to enter the actionable content parameters, a form is returned for an Administrator to assign the Access Parameters and Permissions and the details about the actionable content to be added including file name, text for the actionable content link, clickable graphic, test description, number of questions, date results expire, permission to retake, retake parameters and grading detail.

After all this information is entered and submitted, the Correct Parameters? (290) function processes the transaction and checks the upload form for completeness per the operational parameters for actionable content. If the information is not complete per the operational parameters, an error message is displayed and an Administrator is returned to the form to complete the information. If the information is complete per the operational parameters, the Process Actionable Content Parameters (505) function is performed which loads the parameters for the file and displays a form for the Administrator to enter the questions and answers associated with the document.

The Input Actionable Content Questions (510) function is performed by inputing on the question form the question type, and the associated questions, answer options, and the correct answer. The Administrator also enters the detailed answer text and assigns a point value for the question. After this information is submitted, the Correct Parameters? (290) function processes the transaction and makes sure the information is complete per the operational parameters for this data. If it is not, an error message is displayed and an Administrator is returned to the input question form to complete the information. If the information is complete, the question is processed and this loop is continued until all of the questions for that test are entered correctly per the parameters.

If the question entered is the last question (530), the administrator performs the Set Access Permissions and Display Parameters (540) function, which provides a form for entering the access permissions for the test. If it is not the last question, the Administrator proceeds to enter the next question.

After this data is entered, the administrator submits the questions which triggers Update the Actionable Content Database (550) function, which loads the data in the Actionable Content Database.

Integrated Messaging Component

The administrator can send a message in two principle ways. A message link can be displayed on the User-Trainee's navigation bar, which the User-Trainee can access by clicking on the icon for the link or a message link can be imbedded in content displayed on the User-Trainee Home Page or in other content in the site. The message links can use the User-Trainee's client-based E-mail system or an integrated messaging form which is an Actionable Document.

Referring now to FIG. 4(c), a flow chart is shown of the messaging and performance monitoring functions. After User Logon Initiation (200), Valid ID? (210), and Retrieve Access Parameters (220) functions are performed, the system will Display the Administrator Home Page (230) if the user is an Administrator. From the Home Page, an Administrator can access the Create Message (600) function by clicking the messaging graphic on his or her Home Page. A form is then returned for the Administrator to set the message parameters, fill in the Message title, display date range, required response parameter, and Message text. The Administrator then clicks the submit button to begin the message processing. The Correct Parameters? (290) function will make sure the form is complete per the operational parameters for this data. If it is not, an error message is triggered and the Administrator is taken back to the form to complete the information.

If the message form is complete per the operational parameters, the Update Actionable Content Database (550) function stores the message in the database. The Message Delivery (610) function will send the message to the Home Portal Page of the User-Trainee(s) indicated on the message when the User-Trainee(s) next log on to the system. Notices and alerts can also be sent via traditional email systems to notify the User-Trainee of the message and updates.

Another function of the messaging capability is that an Administrator can lock out a given User-Trainee by setting a Lock Out parameter in the Messaging Form displaying only a message and a link to the referenced actionable content on the User-Trainee's Home Portal Page and requiring compliance before unlocking the site and making it completely accessible once again to that User-Trainee.

Performance Monitoring

Performance monitoring through the capture of Performance Data, when combined with the above-described messaging capabilities, allows an Administrator to monitor and communicate with the User-Trainee based upon the User-Trainee's performance. The advantage to this is that the Admininstrator can access results as soon as a User-Trainee completes the session in which he or she executes Actionable Content.

Referring again to FIG. 4(c), from the Administrator Home Page, the Create Performance Report (620) function can be initiated by clicking on the appropriate icon. A form is returned for the Administrator to select the parameters for the report. For example, the Administrator directing the training on OSHA compliance, can request a report on how all of the trainees did on the Unit 4 test.

The results listed offer the clickable option to drill down more deeply into the Performance Data. The next level of detail is indicated by a clickable link on the results page offering additional options based on the previous inquiry.

The benefit performance monitoring is that the Administrator can then tailor the User-Trainee's program and communicate with the User-Trainee based upon the performance. For example, if the User-Trainee successfully completed the Unit 4 test on OSHA compliance discussed previously, the Administrator could access the Reference Content Functions from FIG. 4(a) (630) and/or the Actionable Content Functions from FIG. 4(b) (640) to make available new content or modify the content based upon successful completion of prior content. The Administrator can communicate this to the User-Trainee through the system's messaging capability.

In addition to monitoring a single User-Trainee's performance, the performance monitoring features enable an Administrator to track a group of User-Trainees to, for example, track the performance of all the User-Trainees in a particular training program. Based on this performance, the messaging functions then enable the Administrator to communicate either individually or by group of User-Trainees. Similarly, the Administrator can alter either individually or by group of User-Trainees the Reference Content and/or Actionable Content that User-Trainees should have access to based on their performance.

What is claimed is:

1. A computer-based training system for implementing and managing one or more training programs over a network of computers, comprising: a server computer and at least one client computer including, respectively, server and client processors for executing server and client programs; server and client input and output elements for communication between said server and client computers; said server computer further including:
a reference content database, said reference content including instructional material on said training programs;
an actionable content database, said actionable content including at least one test or form for each of said training programs;
a user interface means for a user of said client computer to access said reference content and said actionable content a performance monitoring means for evaluating said user's performance on said actionable content; and
a storage means for storing said user's performance.

2. The Computer-Based Training System of claim 1, wherein said server computer includes a messaging means for an administrator to communicate with said user.

3. The Computer-Based Training System of claim 1, wherein said server computer is configured as a Web server and said client computer includes a Web browser.

4. The Computer-Based Training System of claim 1, wherein said server computer includes a user database said user data including said user's access permissions to said reference content and said actionable content.

5. The Computer-Based Training System of claim 4, wherein said server computer includes an administration access means for entering and editing said user data, said reference data, and said actionable content data.

6. The Computer-Based Training System of claim 5, wherein said server computer includes a set operational parameters means to define and edit parameters for entry of said user data, said reference data, and said actionable content data.

7. The Computer-Based Training System of claim 4, wherein said server computer includes a content processing means to permit said user to only view said reference content and said actionable content to which said user has access based on said user's access permissions.

8. The Computer-based Training System of claim 5, wherein said administration access means for entering and editing said actionable content includes an input actionable content parameters means for entering question types, questions, permissible responses, and scoring algorithms.

9. The Computer-based Training System of claim 8, wherein said performance monitoring means includes a scoring means for calculating said user's performance based upon said scoring algorithms.

10. The Computer-based Training System of claim 3, wherein said server computer further includes a performance-based update access permission means to update said user's access permission based upon said user's performance on said actionable content.

11. A computer-based training system for implementing and managing one or more training programs over a network of computers, comprising: a server computer and at least one client computer including, respectively, server and client processors for executing server and client programs; server and client input and output elements for communication between said server and client computers; said server computer further including:
a content management means for entering and storing reference content and actionable content said reference content including instructional material on said training programs and said actionable content including at least one test for each of said training programs;
a user management means for entering a user's access permissions to said reference content and said actionable content;
a user interface means for said user to access said reference content and said actionable content;
a content processing means to permit said user to only view said reference content and said actionable content to which said user has access based on said user's access permissions;
a performance monitoring means for calculating said user's performance on said actionable content; and
a storage means for storing said user's performance.

12. The Computer-Based Training System of claim 11, wherein said server computer is configured as a Web server and said client computer includes a Web browser.

13. The Computer-Based Training System of claim 11, wherein said server computer includes an administration access means for entering and editing said user data, said reference data, and said actionable content data.

14. A method for implementing and managing one or more training programs comprising the steps of:
providing a server computer and at least one client computer including, respectively, server and client processors for executing server and client programs; server and client input and output elements for communication between said server and client computers providing a reference content database said reference content including instructional material on said training programs;
providing an actionable content database, said actionable content including at least one test for each of said training programs;
providing at least one user with access to said reference content and said actionable content;
said user executing said actionable content;
storing said user's performance on said actionable content in a performance database;
updating said reference content and said actionable content based on said user's performance

15. The method of claim 14 further comprising:
providing a user database, said user database including said user's access permissions to said reference content and said actionable content.

16. The method of claim 15 wherein the step of providing at least one user with access to said reference content and said actionable content includes the step of checking said user's access permissions and displaying only said reference content and said actionable content to which said user has access.
